(19) United States
(12) Patent Application Publication
(10) Pub. No.: US 2016/0026616 A1
(43) Pub. Date: Jan. 28, 2016

(54) PRESENTING DATASET OF SPREADSHEET IN FORM BASED VIEW

(71) Applicant: Microsoft Corporation, Redmond, WA (US)

(72) Inventor: Matthew Vogel, Seattle, WA (US)

(21) Appl. No.: 14/445,015

(22) Filed: Jul. 28, 2014

(51) Int. Cl. G06F 17/24

(52) U.S. Cl. CPC G06F 17/246; G06F 17/243

(57) ABSTRACT

A dataset of a spreadsheet is presented in a form based view. The dataset is detected in the spreadsheet. The dataset is configurable for presentation as a form. The dataset is converted into the form. Rows of the dataset are allocated as entries of the form. Cells of a row are allocated as elements of an entry. The form is presented in a form view. Controls are presented to provide an edit operation, a delete operation, a create operation, among others to allow interactivity with the dataset in the form.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications render content through a display and enable users to provide input associated with the applications' operations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to presenting a dataset of a spreadsheet in a form based view. In some example embodiments, a spreadsheet application may detect a dataset in a spreadsheet to be presented on a display of a mobile computing device. The dataset may be configurable for presentation as a form. The dataset may be converted into the form. The rows of the dataset may be allocated as entries in the form. Cells of a row may be allocated as elements of an entry. The form may be presented in a form view of the spreadsheet application on the display of the mobile computing device.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating components of a scheme to present a dataset of a spreadsheet in a form based view, according to embodiments;

FIG. 2 illustrates an example of a dataset of a spreadsheet that is converted and presented as a form, according to embodiments;

FIG. 3 illustrates an example of create operations associated with a dataset that is presented as a form, according to embodiments;

FIG. 4 illustrates an example of presenting multiple entries of a form in a form view, according to embodiments;

FIG. 5 is a simplified networked environment, where a system according to embodiments may be implemented;

FIG. 6 illustrates a general purpose computing device, which may be configured to present a dataset of a spreadsheet in a form based view; and

FIG. 7 illustrates a logic flow diagram for a process to present a dataset of a spreadsheet in a form based view, according to embodiments.

### DETAILED DESCRIPTION

As briefly described above, dataset of a spreadsheet may be presented in a form based view by a spreadsheet application. The spreadsheet application may detect a dataset in a spreadsheet. The spreadsheet may be identified as configurable for presentation as a form. The dataset may be converted into the form. The form may be presented in a form view of the spreadsheet application. One or more controls may be presented to provide an edit operation, a delete operation, a create operation, among others to allow interactivity with the dataset in the form.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components to present a dataset of a spreadsheet in a form based view. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

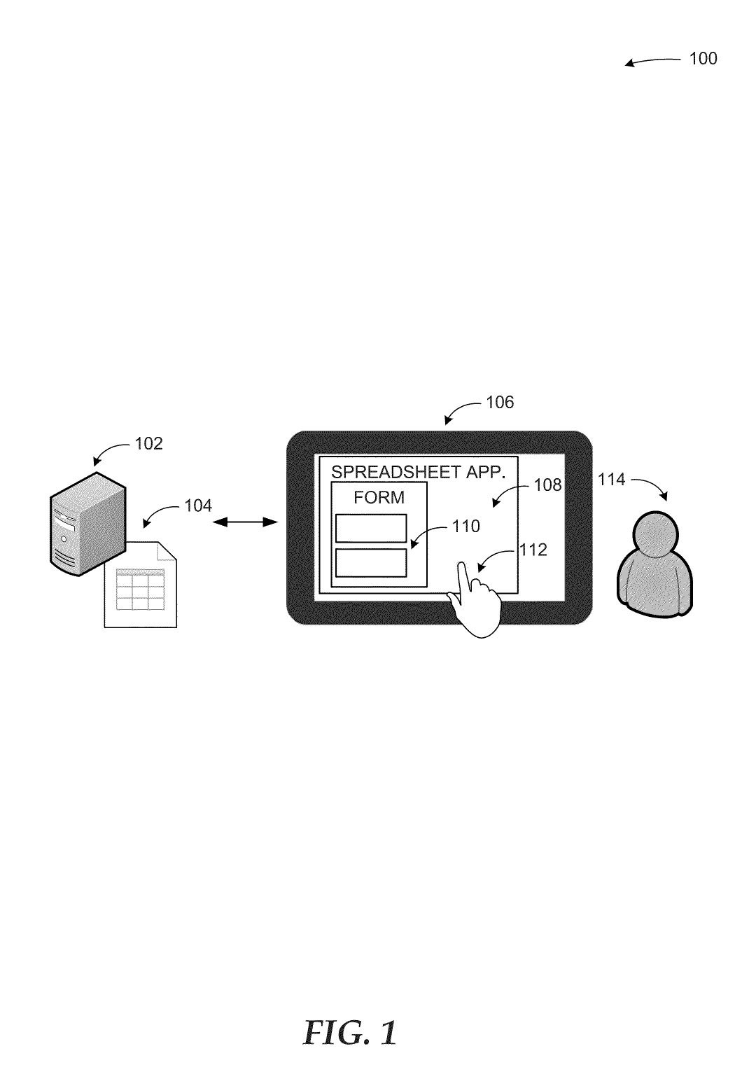

FIG. 1 is a conceptual diagram illustrating components of a scheme to present a dataset of a spreadsheet in a form based view, according to embodiments.

In a diagram 100, a spreadsheet application 108 may present a form 110 of a dataset of a spreadsheet 104 to a user 114. Alternatively, a browser application, a document processing application, a presentation application, among others may be configured to present the form 110. The spreadsheet application 108 may be executed in a device 106. The device 106 may be a mobile computing device such as a tablet, a notebook computer, a smartphone, among others. Alternatively, the device 106 may include a mobility restricted computing device such as a desktop computer, a workstation, among others. The spreadsheet application 108 may retrieve the spreadsheet 104 from a content provider 102. The content provider may be a local or a remote computing device such as a server or a data store that is used to store and provide content such as the spreadsheet 104. Alternatively, the spreadsheet 104 may be retrieved from a local storage of the device 106.

The spreadsheet application 108 may process the spreadsheet 104 to locate datasets that may be presented as a form. A dataset, that may be presentable as a form, may have relational structure between its elements. An example of the dataset may include a table that has rows that may be converted into entries in a form. Another example of the dataset may include a dataset with a data that is formatted in a tabular format.

After identifying the dataset that may be presented as a form, the spreadsheet application 108 may convert the dataset into the form 110. The spreadsheet application 108 may automatically convert the dataset to the form 110. Alternatively, an input from the user 114 may initiate a conversion of the dataset to the form 110. Additionally, the spreadsheet application 108 may provide one or more controls to allow the user 114 to interact with a user interface (UI) of the spreadsheet application 108 or the form 110.

The user 114 may interact with the UI of the spreadsheet application 108 through a number of input modalities that may include a touch based action 112, a keyboard based input, a mouse based input, among others. The touch based action 112 may include a number of gestures such as touch action, a swipe action, among others.

While the example system in FIG. 1 has been described with specific components including the spreadsheet application 108, the form 110, and the spreadsheet 104, embodiments are not limited to these components or system configurations and can be implemented with other system configuration employing fewer or additional components.

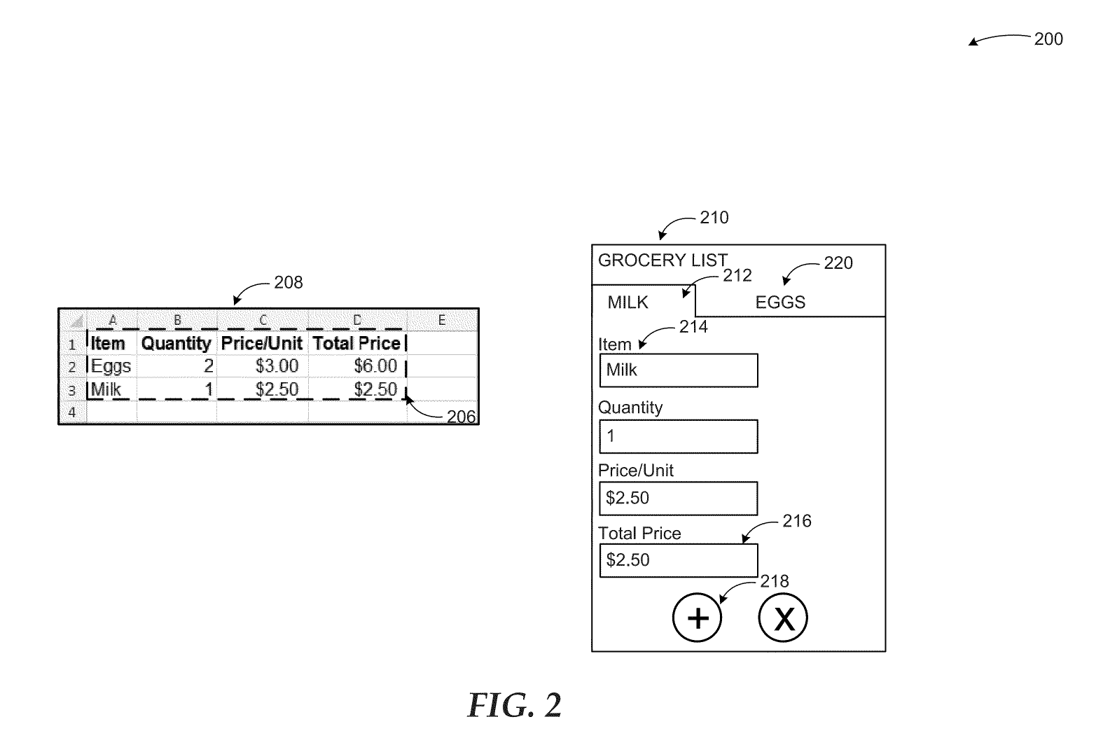

FIG. 2 illustrates an example of a dataset of a spreadsheet that is converted and presented as a form, according to embodiments.

In a diagram 200, a spreadsheet application may process a spreadsheet 208 to identify a dataset 206 that is configurable to present as a form 210. The dataset 206 may be identified as configurable to the form 210 through an analysis of a metadata of the spreadsheet 208. Information associated with a creation of the spreadsheet with a form creation tool may be located in the metadata of the spreadsheet 208. The form creation tool may be a component of the spreadsheet application that is presented to a user to generate a form and save the form as the spreadsheet 208. The form creation tool may also be a third party application used to generate forms and save the data associated with the forms as spreadsheets. A tag such as an XML tag may be embedded into the metadata of the spreadsheet 208 to identify the spreadsheet 208 as created by the form creation tool. As a consequence of creation by the form creation tool, the spreadsheet 208 may store structured data such as the dataset 206. As such, the spreadsheet application may verify that the dataset 206 is configurable for presentation as the form 210.

The spreadsheet application may also identify a table in an object model of the spreadsheet 208. The table may include structured data that may include related cells that are stored in rows. Rows of the dataset 206 may be presented as entries in the form 210. The spreadsheet application may verify that the dataset 206 is configurable for presentation as the form 210 after identifying the table in the dataset 206.

The spreadsheet application may additionally identify the dataset 206 to include data in a tabular format. The data in tabular format may include structured data that is separated by a character such as tab character, a new line character, among others. The structured data may include entities that correspond to rows in a table. As such, the dataset 206 with data formatted in tabular format may be verified as configurable for presentation as the form 210.

A row of the dataset 206 may be allocated as an entry 212 of the form 210 that is displayed on the form view. The form view may display the entry 212 in the foreground. Another row of the dataset 206 may be displayed as a background entry 220 that may be brought to foreground in response to a user action. Furthermore, cells of the row may be allocated to elements of the entry 212 such as an element 214. In addition, a formula may also be identified in a cell of the dataset 206. The formula may describe a value to be computed from values of one or more cells of the dataset 206. A value associated with the formula may be computed by the spreadsheet application. The value may be placed into another element 216 in the form 210. The value may be placed into the other element 216 that corresponds to a cell associated with the formula.

One or more controls 218 may also be provided with the form view. The controls 218 may provide functionality such as an edit operation, a delete operation, a create operation, among others in relation to the entry 212 that is displayed in the foreground.

The form 210 may also be presented in response to a detection of a selection action on the spreadsheet 208. The selection action may include a selection of a title of a row of the dataset 206. The row may be presented as the entry 212 of the form 210 in the form view.

Additionally, the form 210 may also be presented in response to a detection of another selection action on the spreadsheet 208. The selection action may include a selection of a title of a column of the dataset 206. The rows of the dataset 206 may be presented as entries of the form 210 arranged horizontally or vertically in the form view. A focus on each one of the entries may be changeable with a horizontal action on the form view such as a horizontal swipe action to scroll through the entries. Alternatively, a focus on each one of the entries may be changeable with a vertical action on the form view such as a vertical swipe action to scroll through the entries.

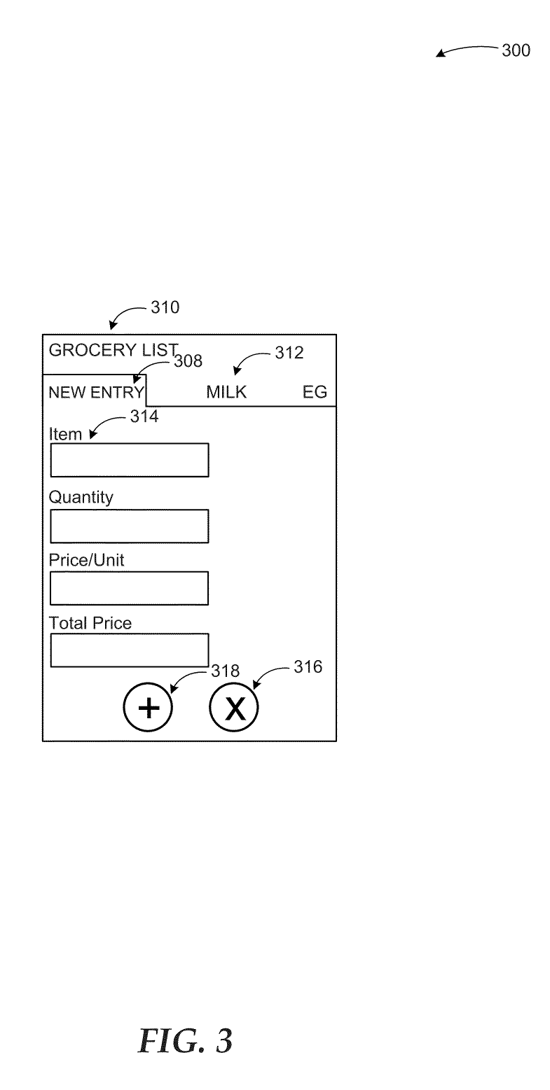

FIG. 3 illustrates an example of create operations associated with a dataset that is presented as a form, according to embodiments.

In a diagram 300, a spreadsheet application may present a form 310 in a form view. The form 310 may be generated from a dataset of a spreadsheet. An add control 318 and a delete control 316 may be displayed to provide create operations in relation to the form 310. In an example scenario, the spreadsheet application may display an entry 312 in a foreground of the form view. A user action may activate the delete control 316. A delete operation may be executed to delete the entry 312. The entry 312 may be removed from the form 310. Furthermore, a row of the dataset of the spreadsheet that corresponds to the entry 312 may be deleted.

In an example scenario, the spreadsheet application may present a new entry 308 in response to a detection of the add control 318. Elements with empty input fields may be presented such as an element 314. The elements may correspond to cells of a row of the dataset of the spreadsheet. Each entry into the elements may be stored in a corresponding cell in a new row of the spreadsheet. A value of an element that is computed from a formula may be computed automatically after a detection of values inputted into other elements associated with the formula. The value associated with the formula may be stored in a corresponding cell in the new row of the spreadsheet.

Additional controls may be provided to allow a user to scroll through the entries presented in the form view. The scroll controls may execute operations to allow an entry in the background of the form 310 to replace an entry in the foreground of the form 310 to bring the background entry into the foreground of the form view.

In another example scenario, create operations may be provided to allow a user to create values in elements of an existing entry such as the entry 312. The entry 312 may be displayed in the foreground in response to user actions to create the entry 312. The user may be allowed to interact with value fields associated with the elements to change the values of the elements of the entry 312. The changed values may be stored in corresponding cells in the spreadsheet. Some value fields may be disabled to prevent interactions with the user. An example may include an element with a value field that is computed using a formula. The spreadsheet application may automatically compute the value of the element based on the formula in response to changes in values of elements associated with the formula.

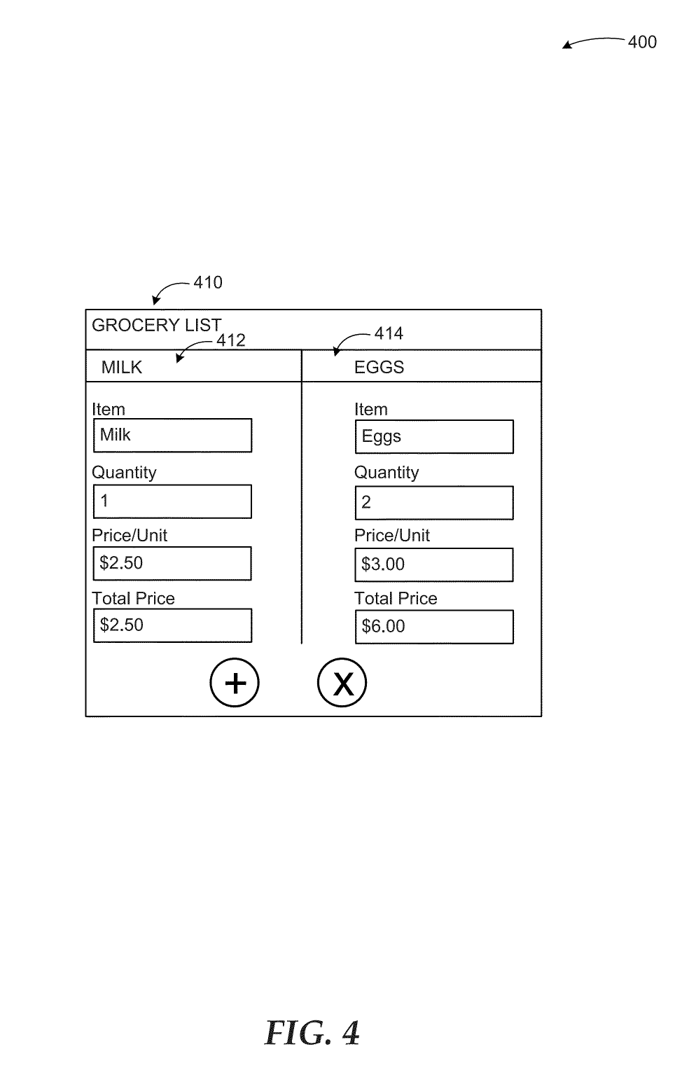

FIG. 4 illustrates an example of presenting multiple entries of a form in a form view, according to embodiments.

In a diagram 400, a spreadsheet application may display multiple entries of a dataset of a spreadsheet in a form 410 within a form view. A first entry 412 may be placed adjacent to a second entry 414. The elements of the first entry 412 and the second entry 414 may be separated by a separation graphic such as a line. Elements with a same title may be lined adjacent to each other. Although the first entry 412 and the second entry 414 may be shown in a horizontal scheme, the first entry 412 and the second entry 414 may also be placed in a vertical scheme. Alternatively, the first entry 412 and the second entry 414 may be stacked adjacent to each other vertically or horizontally with hidden elements. The hidden elements may be displayed based on an a vertical or a horizontal orientation of the first entry 412 and the second entry 414 in response to a user interaction to expand the first entry 412 or the second entry 414. The displayed elements may be re-hidden in response to another user action to hide the displayed elements.

Controls may be provided to scroll through the first entry 412, the second entry 414, and other entries of the form 410. Alternatively, the spreadsheet application may provide scroll functionality through the first entry 412, the second entry 414, and other entries of the form 410 vertically or horizontally based on an orientation of an arrangement of the entries on the form 410 and a direction of a user action. The user action may include a swipe action, among others, on a touch based device that provides the spreadsheet application.

The technical effect of presenting a dataset of a spreadsheet in a form based view may include enhancement of edit, view, and create functionality associated with the dataset in view screen limited environments such as mobile devices.

The example scenarios and schemas in FIG. 2 through 4 are shown with specific components, data types, and configurations. Embodiments are not limited to systems according to these example configurations. Presenting a dataset of a spreadsheet in a form based view may be implemented in configurations employing fewer or additional components in applications and user interfaces. Furthermore, the example schema and components shown in FIGS. 2 and 4 and their subcomponents may be implemented in a similar manner with other values using the principles described herein.

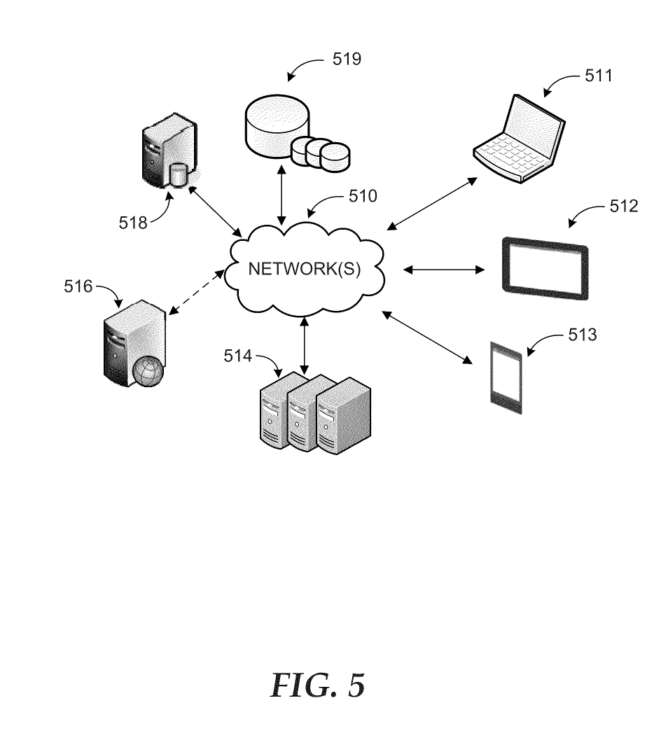

FIG. 5 is an example networked environment, where embodiments may be implemented. A spreadsheet application configured to present a dataset of a spreadsheet in a form based view may be implemented via software executed over one or more servers 514 such as a hosted service. The dataset may be stored locally in relation to a computing device that is configured to execute the spreadsheet application. Alternatively, the dataset may be stored remotely and may be retrieved by the spreadsheet application to convert into a form. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. A spreadsheet application may identify a dataset as configurable into a form, convert the dataset into the form, and present the form. The spreadsheet application may store data associated with the spreadsheet in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to present a dataset of a spreadsheet in a form based view. Furthermore, the networked environments discussed in FIG. 5 are for illustration purposes only. Embodiments are not limited to the example applications, modules, or processes.

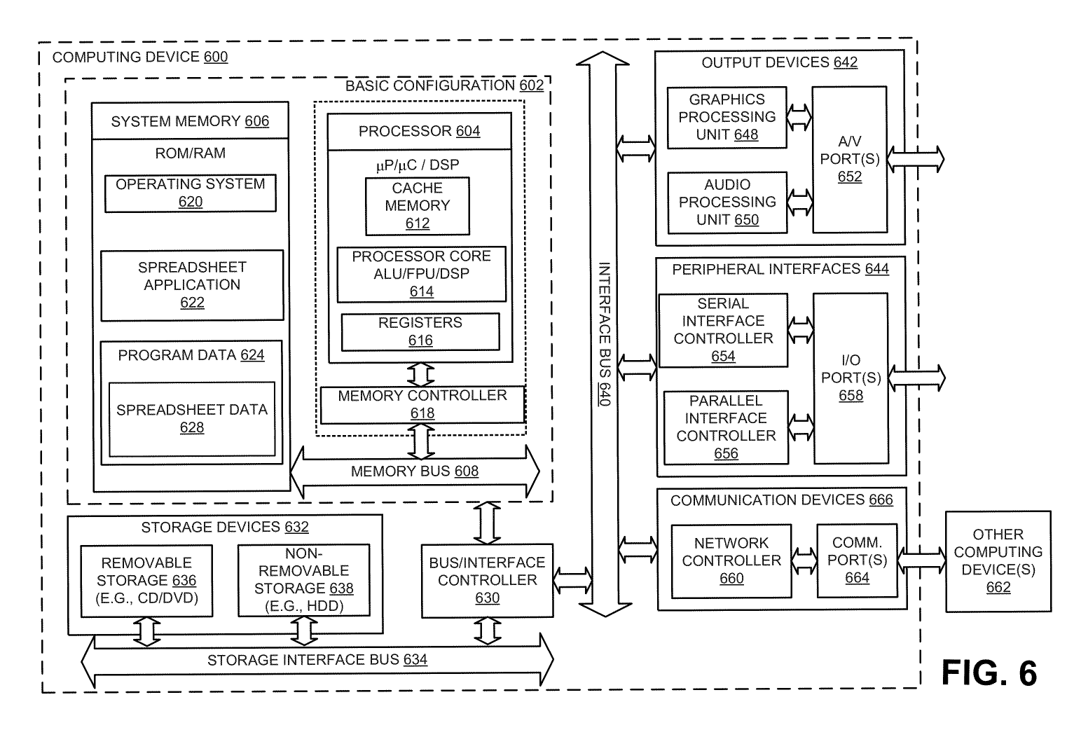

FIG. 6 illustrates a general purpose computing device, which may be configured to present a dataset of a spreadsheet in a form based view, arranged in accordance with at least some embodiments described herein.

For example, the computing device 600 may be used to present a dataset of a spreadsheet in a form based view. In an example of a basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including, but not limited to, a microprocessor (μP), a microcontroller (μC), a digital signal processor (DSP), or any combination thereof. The processor 604 may include one more levels of caching, such as a level cache memory 612, a processor core 614, and registers 616. The processor core 614 may include an arithmetic logic unit (ALU), a floating point unit (FPU), a digital signal processing core (DSP Core), or any combination thereof. A memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a spreadsheet application 622, and a program data 624. The spreadsheet application 622 may present a dataset of a spreadsheet as a form. The program data 624 may include, among other data, a spreadsheet data 628, or the like, as described herein. The spreadsheet data 628 may include a dataset that may be presented as a form.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636, and the non-removable storage devices 638 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 may include a graphics processing unit 648 and an audio processing unit 650, which may be configured to communicate to various external devices, such as a display or speakers via one or more A/V ports 652. One or more example peripheral interfaces 644 may include a serial interface controller 654 or a parallel interface controller 656, which may be configured to communicate with external devices, such as input devices (for example, keyboard, mouse, pen, voice input device, touch input device, etc.) or other peripheral devices (for example, printer, scanner, etc.) via one or more I/O ports 658. An example communication device 666 may include a network controller 660, which may be arranged to facilitate communications with one or more other computing devices 662 over a network communication link via one or more communication ports 664. The one or more other computing devices 662 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include presentation of a dataset of a spreadsheet in a form based view. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

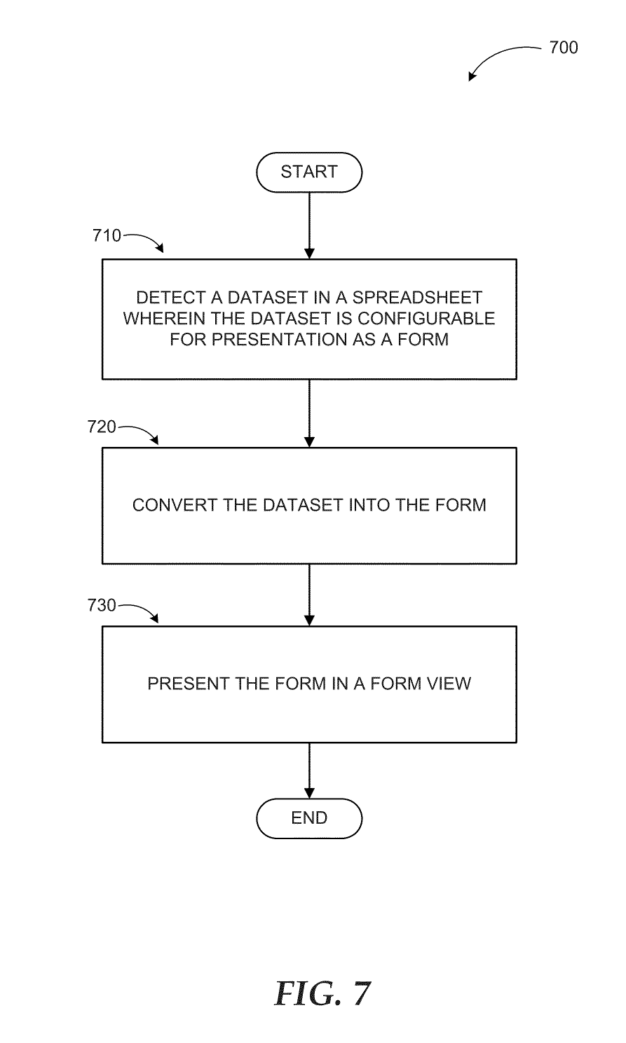

FIG. 7 illustrates a logic flow diagram for a process to present a dataset of a spreadsheet in a form based view, according to embodiments. Process 700 may be implemented on a spreadsheet application.

Process 700 begins with operation 710, where a dataset of a spreadsheet may be detected. The dataset may be configurable for presentation as a form. At operation 720, the dataset may be converted into the form. The rows of the dataset may be allocated as entries of the form. The form may be presented in a form view at operation 730.

The operations included in process 700 are for illustration purposes. A spreadsheet application according to embodiments may be implemented by similar processes with fewer or additional steps, as well as in different order of operations using the principles described herein.

According to some examples, a method that is executed on a mobile computing device to present a dataset of a spreadsheet in a form based view may be described. The method may include detecting the dataset in the spreadsheet to be presented on a display of the mobile computing device, where the dataset is configurable for presentation as a form, converting the dataset into the form, and presenting the form in a form view on the display of the mobile computing device.

According to other examples, the method may further include locating, in a metadata of the spreadsheet, information associated with a creation of the spreadsheet with a form creation tool and verifying that the dataset is configurable for presentation as the form. A table may be identified in an object model of the spreadsheet and the dataset's configurability for presentation as the form may be verified. The dataset may be identified to include data in a tabular format and the dataset's configurability for presentation as the form may be verified.

According to further examples, the method may further include allocating a row of the dataset as an entry of the form for each row in the dataset and allocating a cell of the row as an element of the entry of the form for each cell in the row. A selection action on the spreadsheet may be detected to select a cell of a row of the dataset and the row may be presented as an entry of the form in the form view. A selection action may be detected on the spreadsheet to select a title of a row of the dataset and the row may be presented as an entry of the form in the form view. A selection action on the spreadsheet may be detected to select a title of a column of the dataset. One or more rows of the dataset may be presented as one or more entries of the form arranged horizontally in the form view, where a focus on each of the one or more entries is changeable based on a detection of a horizontal action on the form view. One or more rows of the dataset may be presented as one or more entries of the form arranged vertically in the form view, where a focus on each of the one or more entries is changeable based on a detection of a vertical action on the form view.

According to some examples, a portable computing device to present a dataset of a spreadsheet in a form based view may be described. The portable computing device may include a display, a memory, a processor coupled to the memory. The processor may be configured to execute a spreadsheet application in conjunction with instructions stored in the memory. The spreadsheet application may be configured to detect the dataset in the spreadsheet, where the dataset is identified to include one from a set of: a table, and a data in a tabular format, convert the dataset into the form, and present the form in a form view on the display of the portable computing device.

According to other examples, the spreadsheet application is further configured to generate one or more entries of the form from one or more rows of the dataset. One or more controls may be provided to edit the one or more entries presented in the form view and in response to a detection of one or more edits of the one or more entries, the one or more edits may be saved to the one or more rows of the dataset that correspond to the one or more entries in the spreadsheet and the one or more edits may be presented within the one or more entries in the spreadsheet that correspond to the one or more rows. One or more controls may be provided to scroll through the one or more entries presented in the form view.

According to some examples, the spreadsheet application is further configured to identify one or more formulas in one or more cells of the dataset and compute values associated with the one or more formulas. The values may be placed into elements in the form that correspond to the one or more cells.

According to some examples, a computer-readable memory device with instructions stored thereon to present a dataset of a spreadsheet in a form based view may be described. The instructions may include actions that are similar to the method described above.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to present a dataset of a spreadsheet in a form based view for restricted displays, the method comprising:
detecting the dataset in the spreadsheet to be presented in a mobile device display, wherein the dataset is configurable for presentation as a form;
converting the dataset into the form; and
presenting the form in a form view on the mobile device display.

2. The method of claim 1, further comprising:
locating, in a metadata of the spreadsheet, information associated with a creation of the spreadsheet with a form creation tool; and
verifying that the dataset is configurable for presentation as the form.

3. The method of claim 1, further comprising:
identifying a table in an object model of the spreadsheet; and
verifying that the dataset is configurable for presentation as the form.

4. The method of claim 1, further comprising:
identifying the dataset to include data in a tabular format; and
verifying that the dataset is configurable for presentation as the form.

5. The method of claim 1, further comprising:
allocating a row of the dataset as an entry of the form for each row in the dataset.

6. The method of claim 5, further comprising:
allocating a cell of the row as an element of the entry of the form for each cell in the row.

7. The method of claim 1, further comprising:
detecting a selection action on the spreadsheet to select a cell of a row of the dataset; and
presenting the row as an entry of the form in the form view.

8. The method of claim 1, further comprising:
detecting a selection action on the spreadsheet to select a title of a row of the dataset; and
presenting the row as an entry of the form in the form view.

9. The method of claim 1, further comprising:
detecting a selection action on the spreadsheet to select a title of a column of the dataset.

10. The method of claim 9, further comprising:
presenting one or more rows of the dataset as one or more entries of the form arranged horizontally in the form view, wherein a focus on each of the one or more entries is changeable based on a detection of a horizontal action on the form view.

11. The method of claim 1, further comprising:
presenting one or more rows of the dataset as one or more entries of the form arranged vertically in the form view, wherein a focus on each of the one or more entries is changeable based on a detection of a vertical action on the form view.

12. A portable computing device to present a dataset of a spreadsheet in a form based view, the portable computing device comprising:
a display;
a memory;
a processor coupled to the memory and the display, the processor executing a spreadsheet application in conjunction with instructions stored in the memory, wherein the spreadsheet application is configured to:
detect the dataset in the spreadsheet, wherein the dataset is identified to include one from a set of: a table, and a data in a tabular format;
convert the dataset into the form; and
present the form in a form view on the display of the portable computing device.

13. The portable computing device of claim 12, wherein the spreadsheet application is further configured to:
generate one or more entries of the form from one or more rows of the dataset.

14. The portable computing device of claim 13, wherein the spreadsheet application is further configured to:
provide one or more controls to edit the one or more entries presented in the form view;
in response to a detection of one or more edits of the one or more entries,
save the one or more edits to the one or more rows of the dataset that correspond to the one or more entries in the spreadsheet; and
present the one or more edits within the one or more entries in the spreadsheet that correspond to the one or more rows.

15. The portable computing device of claim 13, wherein the spreadsheet application is further configured to:
provide one or more controls to scroll through the one or more entries presented in the form view.

16. The portable computing device of claim 12, wherein the spreadsheet application is further configured to:
identify one or more formulas in one or more cells of the dataset; and
compute values associated with the one or more formulas.

17. The portable computing device of claim 12, wherein the spreadsheet application is further configured to:
place the values into elements in the form that correspond to the one or more cells.

18. A computer-readable memory device with instructions stored thereon to present a dataset of a spreadsheet in a form based view, the instructions comprising:
detecting the dataset in the spreadsheet to be presented on a display of a portable computing device, wherein the dataset is identified from information, within a metadata of the spreadsheet, associated with a creation of the spreadsheet with a form creation tool;
converting the dataset into the form; and
presenting the form in a form view on the display of the portable computing device.

19. The computer-readable memory device of claim 18, wherein the instructions further comprise:
generating one or more entries of the form from one or more rows of the dataset;
providing one or more controls to edit the one or more entries presented in the form view; and
in response to a detection of one or more edits of the one or more entries, saving the one or more edits to the one or more rows of the dataset that correspond to the one or more entries in the spreadsheet.

20. The computer-readable memory device of claim 18, wherein the instructions further comprise:
identifying one or more formulas in one or more cells of the dataset;
computing values associated with the one or more formulas; and
placing the values into elements in the form that correspond to the one or more cells.
